(19) United States
(12) Patent Application Publication
(10) Pub. No.: US 2024/0251918 A1
(43) Pub. Date: Aug. 1, 2024

(54) PIPING ZIPPER ASSEMBLY, BOX BODY AND BOX BODY PRODUCTION TECHNOLOGY

(71) Applicant: SHANGHAI GATHEY SCIENCE AND TECHNOLOGY DEVELOPMENT CO., LTD, Shanghai (CN)

(72) Inventors: Tongzhou WAN, Shanghai (CN); WU ZHONGHUA, Shanghai (CN)

(21) Appl. No.: 18/560,025

(22) PCT Filed: May 9, 2022
(86) PCT No.: PCT/CN2022/091631

§ 371 Date: Nov. 9, 2023

(30) Foreign Application Priority Data
May 10, 2021 (CN) 202110505416.9
May 10, 2021 (CN) 202120985320.2

(51) Int. Cl. A44B 19/24; A45C 5/03; A45C 13/10; B29D 5/10

(52) U.S. Cl. CPC A44B 19/24; A45C 5/03; A45C 13/103; B29D 5/10

(57) ABSTRACT

A piping zipper assembly, a box body and a box body production technology. One side of a zipper and a piping are formed into an integral piping zipper assembly by a coextrusion technology. Then, the piping zipper assembly is directly and accurately installed on the edge of a box shell through the piping, so as to realize the connection of the piping zipper assembly and the box shell. The step is simple, the production efficiency is high, and the production cost can be reduced. Compared with the existing production process in which the piping and the zipper are assembled on the box shell respectively and sewn to the box shell, the present invention greatly saves the installation time and solves the problem of low production efficiency in the existing production process. Meanwhile, the automation of luggage production can be realized.

### TECHNICAL FIELD

The present invention belongs to the technical field of bags, and particularly relates to a piping zipper assembly, a box body and a box body production technology.

### BACKGROUND

At present, the modes of sewing zippers for luggage related products on the market are basically consistent, and are all traditional practices, such as extrusion of piping sewn on a luggage shell. The commonly used materials include PVC, TPE, TPU, etc. The role of the piping is to wrap the cutting surface of the luggage shell for protecting users or zippers from being cut by the mechanically cut edge. The zippers are woven. The zippers are inserted into the piping and sewn together with the luggage shell. At this time, the piping and the zippers are alternately locked on the luggage shell by sewing lines, to complete the assembly of half the luggage shell.

According to the conventional production process, the process that a luggage product needs to complete on the sewing zippers is to produce the piping, produce the zippers, and sew the zippers and the piping together on the luggage shell. This conventional production mode is inefficient, and automation equipment is difficult to be used in the production of luggage products, causing long assembly time, low production efficiency and high production cost.

### SUMMARY

A technical problem to be solved by the present invention is to provide a piping zipper assembly and a box body production technology, to solve the problem of low production efficiency in the existing production process.

To solve the above problem, the present invention adopts the following technical solution:

A piping zipper assembly of the present invention comprises a piping and a zipper:

The piping comprises a piping body, and the piping body comprises an upper surface and a lower surface which are opposite: the upper surface is provided with a first connecting groove connected with a box shell; and the lower surface is provided with a connecting region:

A selvage of the zipper is connected to the connecting region and coextruded with the piping body.

In some embodiments, the piping is directly connected with the selvage of the zipper in the process of fabrication and molding.

In some embodiments, the piping is made of TPE material or PP material.

In some embodiments, the piping further comprises an upper connecting component; and the upper connecting component is arranged on the upper surface and matched with the upper surface to form the first connecting groove.

In some embodiments, one surface of the upper connecting component away from the first connecting groove is provided with an accessory connecting structure for connecting an accessory.

In some embodiments, the accessory connecting structure is a chute structure, one end of the accessory has a T-part matched with the chute structure, and the T-part is arranged in the chute structure; and the accessory is a hook.

In some embodiments, the piping further comprises a lower connecting component; and the lower connecting component is arranged on the lower surface and matched with the lower surface to form a coextrusion connecting groove, and an inner cavity of the coextrusion connecting groove is the connecting region.

In some embodiments, the piping further comprises splints: the splints are arranged below the lower surface at intervals and matched with the lower surface to form a coextrusion gap; and the coextrusion gap is the connecting region.

In some embodiments, the selvage of the zipper is provided with a plurality of through holes for allowing the material of the piping to penetrate through the through holes during coextrusion.

In some embodiments, the zipper is a double-sided toothed zipper: the double-sided toothed zipper comprises the selvage, and a first sprocket and a second sprocket which are arranged on both sides of the selvage: the first sprocket is combined with another box shell, and the second sprocket is combined with a lining in the box shell.

In some embodiments, the zipper comprises the selvage, one side of the selvage is provided with two or more sprockets, and the two or more sprockets are arranged up and down in parallel.

In some embodiments, the zipper comprises the selvage, and two or more sprockets are arranged side by side on the same surface at one side of the selvage.

In some embodiments, the selvage of the zipper and the piping body are formed by hot melting or ultrasonic waves or bonding.

The present invention further provides a box body production technology for producing the piping zipper assembly and installing the piping zipper assembly to the box body, comprising the following specific steps:
S1: pre-embedding the selvage of the zipper into the connecting region when the piping is produced;
S2: coextruding the piping and the zipper to form the piping zipper assembly;
S3: installing the piping zipper assembly to the box shell by a manipulator to form a box body.

In some embodiments, in step S3, the box shell is connected with the first connecting groove of the piping zipper assembly by ultrasonic waves or glue or sewing technology.

The present invention further provides a box body, comprising the above piping zipper assembly.

Compared with the prior art, the present invention has the following advantages and positive effects due to adoption of the above technical solution:

In an embodiment of the present invention, the piping body is divided into the upper surface connected with the box shell and the lower surface connected with the zipper, and the selvage of the zipper and the piping body are formed by the coextrusion technology into an integral piping zipper assembly. The piping zipper assembly can achieve the purpose of cladding the edge of the box shell, and can also achieve the strength purpose of convenient connection of the zipper. The piping zipper assembly can be directly and accurately installed on the cutting surface of the box shell through the first connecting groove arranged on the piping body, so as to realize the connection of the piping zipper assembly and the box shell. The step is simple, the production efficiency is high, and the production cost can be reduced. Compared with the existing production process in which the piping and the zipper are assembled on the box shell respectively and sewn to the box shell, the present invention greatly saves the installation time and solves the problem of low production efficiency in the existing production process.

The present invention further provides a box body, which comprises a front box body, a rear box body and a zipper assembly. The zipper assembly is connected with the front box body and the rear box body: the zipper assembly comprises a left zipper, a right zipper and a pull head, and one side of the left zipper and one side of the right zipper are connected through a pull head.

The other side of the left zipper is connected with a left piping, the other side of the left zipper is coextruded with the left piping, and the left piping is connected with the front box body: the other side of the right zipper is connected with a right piping, the other side of the right zipper is coextruded with the right piping, and the right piping is connected with the rear box body.

Wherein the left piping is directly connected with the other side of the left zipper in the process of manufacturing and forming, and the right piping is directly connected with the other side of the right zipper in the process of manufacturing and forming.

In some embodiments, each of the left piping and the right piping comprises a piping body, and the piping body comprises an upper surface and a lower surface which are opposite: the upper surface is provided with a first connecting groove connected with the front box body/rear box body; and the lower surface is provided with a connecting region; the selvage of the left zipper/the right zipper is connected to the connecting region and coextruded with the piping body.

In some embodiments, the upper surface of the piping body is connected with an upper connecting component, and the upper connecting component is matched with the upper surface to form the first connecting groove.

In some embodiments, the lower surface of the piping body is provided with a lower connecting component, the lower connecting component is matched with the lower surface to form a coextrusion connecting groove, and an inner cavity of the coextrusion connecting groove is the connecting region.

In some embodiments, splints are arranged below the lower surface of the piping body: the splints are arranged below the lower surface at intervals and matched with the lower surface to form a coextrusion gap; and the coextrusion gap is the connecting region.

In some embodiments, the selvages of the left zipper and the right zipper are provided with a plurality of through holes for allowing the material of the left piping and the right piping to penetrate through the through holes during coextrusion.

In some embodiments, the left zipper and/or the right zipper is a double-sided toothed zipper: the double-sided toothed zipper comprises the selvage, and a first sprocket and a second sprocket which are arranged on both sides of the selvage:

The first sprocket of the left zipper is connected with the first sprocket of the right zipper through the pull head, and the second sprocket of the left zipper is detachably connected with a lining in the front box body:

The first sprocket of the right zipper is connected with the first sprocket of the left zipper through the pull head, and the second sprocket of the right zipper is detachably connected with a lining in the rear box body:

In some embodiments, one side of the selvage of the left zipper and/or the right zipper is provided with two or more sprockets, and the two or more sprockets are arranged up and down in parallel.

In some embodiments, two or more sprockets are arranged side by side on the same surface at one side of the selvage of the left zipper and/or the right zipper.

In some embodiments, the left zipper and the left piping, and the right zipper and the right piping are formed by hot melting or ultrasonic waves or bonding.

In some embodiments, one side of the left piping and/or the right piping that faces outside the box body is provided with an accessory connecting structure for connecting an accessory.

In some embodiments, the accessory connecting structure is a chute structure, one end of the accessory has a T-part matched with the chute structure, and the T-part is arranged in the chute structure; and the accessory is a hook.

Compared with the prior art, the present invention has the following advantages and positive effects due to adoption of the above technical solution:

In the present invention, one side of the zipper and the piping are formed by the coextrusion technology into an integral piping zipper assembly. When the piping is processed, the connection of the zipper is completed. Then, the piping zipper assembly is directly and accurately installed on the edge of the box shell through the piping, so as to realize the connection of the piping zipper assembly and the box shell. The step is simple, the production efficiency is high, and the production cost can be reduced. Compared with the existing production process in which the piping and the zipper are assembled on the box shell respectively and sewn to the box shell, the present invention greatly simplifies the step, greatly saves the installation time and solves the problem of low production efficiency in the existing production process. Meanwhile, the piping and zipper are produced as an integral piping zipper assembly, which can realize the automation of luggage production. Because two manipulators are needed to move the piping and the zipper to the seam of the box shell respectively in the original solution, the steps are complicated and the production cost is high. The integral piping zipper assembly in the present embodiment can be installed on the box shell by one manipulator only, so that the steps are simple and the production cost is low.

### DESCRIPTION OF DRAWINGS

FIG. 1 is a structural schematic diagram of a piping zipper assembly in embodiment 1;

FIG. 2 is a side view of a piping zipper assembly in embodiment 1;

FIG. 3 is an exploded view of a piping zipper assembly in embodiment 1;

FIG. 4 is a structural schematic diagram of a piping zipper assembly in embodiment 2;

FIG. 5 is a side view of a piping zipper assembly in embodiment 2;

FIG. 6 is an exploded view of a piping zipper assembly in embodiment 2;

FIG. 7 is a structural schematic diagram of a piping zipper assembly in embodiment 3;

FIG. 8 is a side view of a piping zipper assembly in embodiment 3;

FIG. 9 is an exploded view of a piping zipper assembly in embodiment 3;

FIG. 10 is a structural schematic diagram of a piping zipper assembly in embodiment 4;

FIG. 11 is a side view of a piping zipper assembly in embodiment 4;

FIG. 12 is an exploded view of a piping zipper assembly in embodiment 4;

FIG. 13 is a structural schematic diagram of a zipper in embodiment 4;

FIG. 14 is a side view of a zipper in embodiment 5;

FIG. 15 is a side view of a piping zipper assembly in embodiment 5;

FIG. 16 is a side view of a zipper when a sprocket 206 is connected with a sprocket 207 in embodiment 6;

FIG. 17 is a side view of a piping zipper assembly when a sprocket 206 is connected with a sprocket 207 in embodiment 6;

FIG. 18 is a side view of a zipper when a sprocket 206 is not connected with a sprocket 207 in embodiment 6;

FIG. 19 is a side view of a piping zipper assembly when a sprocket 206 is not connected with a sprocket 207 in embodiment 6;

FIG. 20 is a side view of a piping in embodiment 7;

FIG. 21 is a side view after a piping is connected with a hook in embodiment 7;

FIG. 22 is a splitting schematic diagram of a box body in embodiment 10;

FIG. 23 is a partial sectional view of a box body in embodiment 10;

FIG. 24 is a structural schematic diagram of a box body of another solution in embodiment 10;

FIG. 25 is a partial sectional view of a box body of another solution in embodiment 10.

### DETAILED DESCRIPTION

The piping zipper assembly and the box body production technology proposed by the present invention will be further described in detail below in combination with the drawings and the specific embodiments. The advantages and the features of the present invention will become clearer according to the following description and claims.

The present invention provides a piping zipper assembly which comprises a piping and a zipper, wherein the piping comprises a piping body, and the piping body comprises an upper surface and a lower surface which are opposite. The upper surface is provided with a first connecting groove connected with a box shell, and the lower surface is provided with a connecting region. A selvage of the zipper is connected to the connecting region and coextruded with the piping body.

The present invention further provides a box body production technology for producing the piping zipper assembly and installing the piping zipper assembly to the box body, specifically comprising the following specific steps: S1: pre-embedding the selvage of the zipper into the connecting region when the piping is produced; S2: coextruding the piping and the zipper to form the piping zipper assembly; and S3: installing the piping zipper assembly to the box shell by a manipulator to form a box body.

The present invention further provides a box body, comprising a front box body, a rear box body and the above zipper assembly.

The present invention further provides a box body, which comprises a front box body, a rear box body and the zipper assembly. The zipper assembly is connected with the front box body and the rear box body. The zipper assembly comprises a left zipper, a right zipper and a pull head, and one side of the left zipper and one side of the right zipper are connected through the pull head. The other side of the left zipper is connected with a left piping, the other side of the left zipper is coextruded with the left piping, and the left piping is connected with the front box body; the other side of the right zipper is connected with a right piping, the other side of the right zipper is coextruded with the right piping, and the right piping is connected with the rear box body, wherein the left piping is directly connected with the other side of the left zipper in the process of manufacturing and forming, and the right piping is directly connected with the other side of the right zipper in the process of manufacturing and forming.

In the piping zipper assembly, the box body and the box body production technology provided by the present invention, the disclosed zipper assembly is composed of the zipper and the piping; and the selvage of the zipper is directly coextruded and connected with the piping, and then installed on the edge of the box body through the piping. Compared with the prior art in which the zipper is inserted into the piping and then the zipper and the piping are sewn on the edge of the box body, the connection mode of the present invention is simple in operation, greatly saves the installation time and solves the problem of low production efficiency in the existing production process. Meanwhile, the piping and zipper are produced as an integral piping zipper assembly, which can realize the automation of luggage production.

The present invention is further described below through specific embodiments.

### Embodiment 1

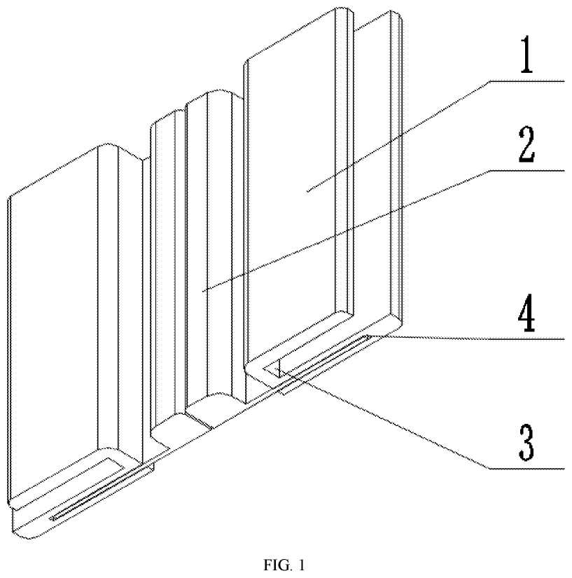

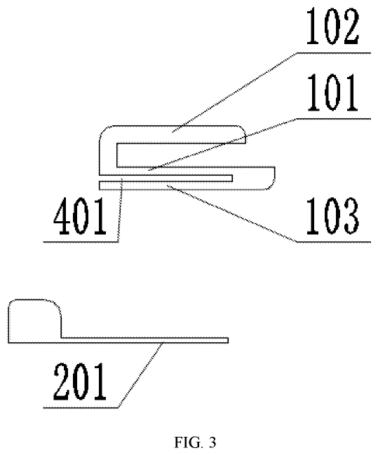

By referring to FIGS. 1-3, the present embodiment provides a piping zipper assembly which comprises a piping 1 and a zipper 2, wherein the piping 1 comprises a piping body 101, and the piping body 101 comprises an upper surface and a lower surface which are opposite. The upper surface is provided with a first connecting groove 3 connected with a box shell, and the lower surface is provided with a connecting region 4. A selvage 201 of the zipper 2 is connected to the connecting region 4 and coextruded with the piping body 101. That is, the selvage of the zipper is pre-embedded into the connecting region when the piping is processed, and the connection with the zipper is realized while the piping is processed.

In the present embodiment, the piping body 101 is divided into the upper surface connected with the box shell and the lower surface connected with the zipper 2, and the selvage 201 of the zipper 2 and the piping body 101 are formed by the coextrusion technology into an integral piping zipper assembly. The piping zipper assembly can achieve the purpose of cladding the edge of the box shell, and can also achieve the strength purpose of convenient connection of the zipper 2. The piping zipper assembly can be directly and accurately installed on the cutting surface of the box shell through the first connecting groove 3 arranged on the piping body 101, so as to realize the connection of the piping zipper assembly and the box shell. The step is simple, the production efficiency is high, and the production cost can be reduced. Compared with the existing production process in which the piping 1 and the zipper 2 are assembled on the box shell respectively and sewn to the box shell, the present patent omits the step that the zipper 2 and the piping are sewn together, greatly saves the installation time and solves the problem of low production efficiency in the existing production process.

Meanwhile, the piping 1 and zipper 2 are produced as an integral piping zipper assembly, which can realize the automation of luggage production. Because two manipulators are needed to move the piping 1 and the zipper 2 to the seam of the box shell respectively in the original solution, the steps are complicated and the production cost is high. The integral piping zipper assembly in the present embodiment can be installed on the box shell by one manipulator only through the first connecting groove 3, so that the steps are simple and the production cost is low. The specific connection mode may be realized by the technologies of ultrasonic waves, glue, sewing, etc.

In the present embodiment, by referring to FIG. 1, the zipper assembly has a left and a right pipings 1; the two pipings 1 are connected with a zipper 2 respectively; the selvage on one side of the zipper 2 is coextruded with the two pipings 1 respectively, and the sprocket on the other side is connected through a pull head.

In the present embodiment, the pipings 1 can also comprise an upper connecting component 102. The upper connecting component 102 may be specifically an L-shaped connecting component. One end is arranged on the upper surface and the other end can be matched with the upper surface to form the first connecting groove 3. In practical installation, the cutting surface of the box shell is directly inserted into the first connecting groove 3 formed between the upper connecting component 102 and the upper surface, and is connected by the technologies of ultrasonic waves or glue or sewing or welding. Of course, in other embodiments, the connection mode of the first connecting groove 3 is not limited to the above, and can also be adjusted according to the specific situation, which is not limited here.

In the present embodiment, the pipings 1 can also comprise a lower connecting component 103. The lower connecting component 103 may also be an L-shaped connecting component. One end is arranged on the lower surface and the other end can be matched with the lower surface to form a coextrusion connecting groove 401. An inner cavity of the coextrusion connecting groove 401 is the above connecting region 4. In practical production, the selvage 201 of the zipper 2 is inserted into the coextrusion connecting groove 401, so that the material of the piping body 101, the material of the lower connecting component 103 and the selvage are coextruded into a whole.

Preferably, the coextrusion mode may be hot melting forming. Of course, in other embodiments, the realization mode of coextrusion may also be ultrasonic wave forming or bonding forming, which is not limited here.

In the present embodiment, the zipper 2 is a one-sided zipper, which comprises a selvage 201, and the selvage 201 is provided with a sprocket on only one side. Of course, in other embodiments, the zipper can also comprise a plurality of sprockets. The concrete structure of the zipper can be adjusted according to the specific situation, which is not limited here.

In the present embodiment, the piping 1 is preferably made of material with certain stiffness and toughness, which is convenient for combining with the box body, so as to ensure that the piping is bent and cladded on the cutting surface of the box body and ensure that the piping has certain connection strength. Specifically, the piping 1 can be made of TPE material or PP material, etc., which is not limited here.

### Embodiment 2

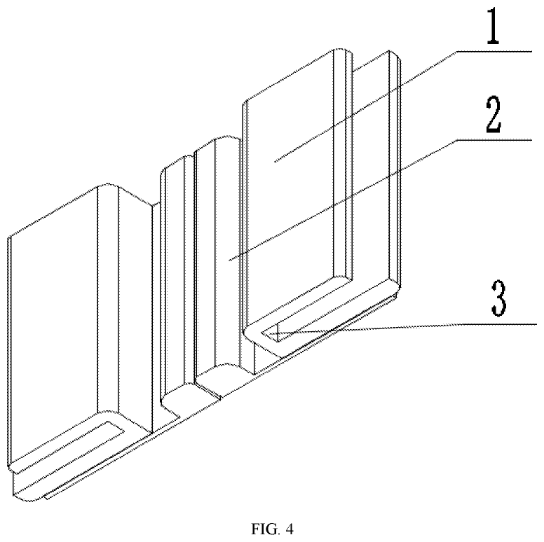

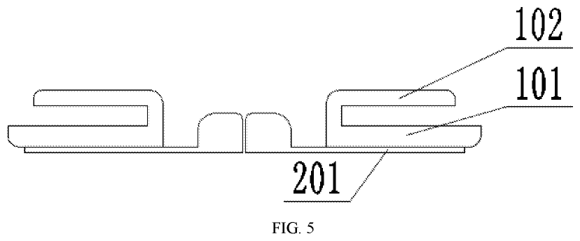

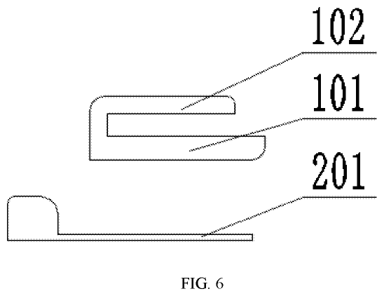

By referring to FIGS. 4-6, the present embodiment is an adjustment based on embodiment 1.

In the present embodiment, the arrangement of the lower connecting component 103 is omitted. The zipper 2 is directly coextruded with the lower surface of the piping body 101, and the produced piping zipper assembly is then installed with the box shell.

The piping assembly provided in the present embodiment further simplifies the structure compared with the piping assembly in embodiment 1.

### Embodiment 3

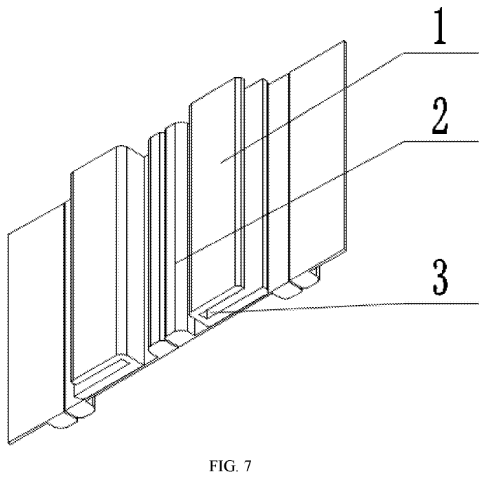

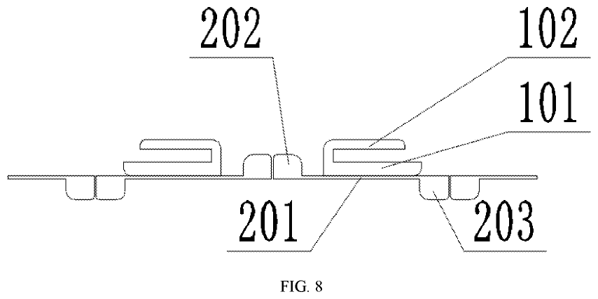

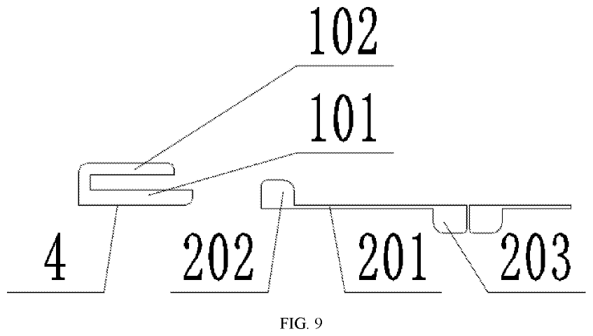

By referring to FIGS. 7-9, the present embodiment is an adjustment based on embodiment 2.

In the present embodiment, the arrangement of the lower connecting component 103 is omitted, and the zipper 2 is a double-sided toothed zipper.

Specifically, the double-sided toothed zipper comprises a selvage 201, and a first sprocket 202 and a second sprocket 203 which are arranged on both sides of the selvage 201. The first sprocket 202 is combined with the other half of box body, and the second sprocket 203 is combined with a lining in the box shell. The edge of the lining is also provided with a ring of sprockets, and can be directly connected with the box body through the pull head, so that the lining can be quickly disassembled and cleaned, thereby solving the problem that the linings of the current luggage products cannot be disassembled and cleaned.

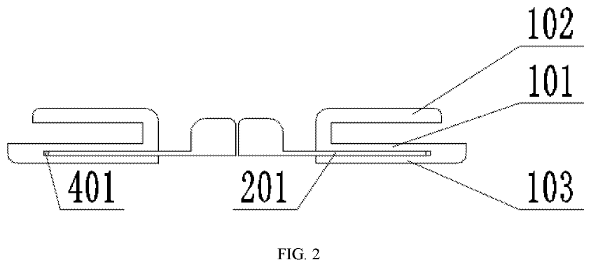

Further, the selvage 201 of the zipper 2 is directly coextruded with the lower surface of the piping body 101, and the first sprocket 202 and the second sprocket 203 are distributed on both sides of the lower surface of the piping body 101, as shown in FIG. 2.

### Embodiment 4

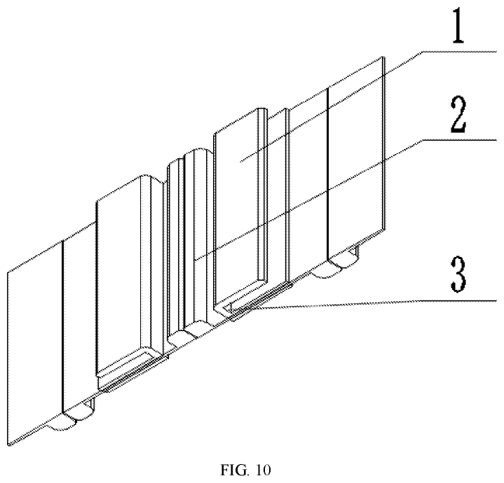

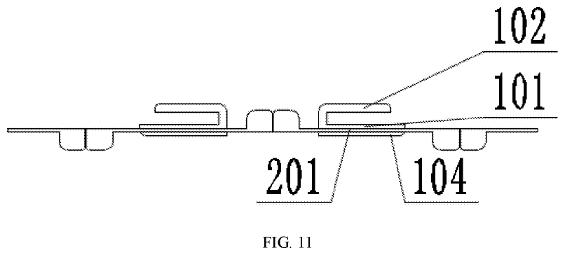

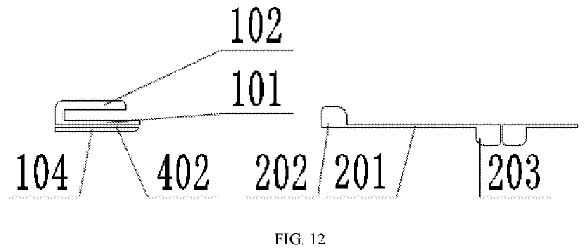

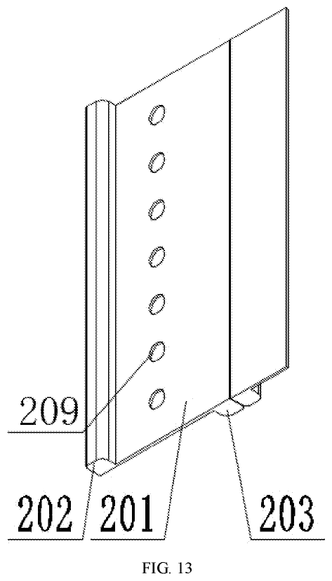

By referring to FIGS. 10-13, the present embodiment is an adjustment based on embodiment 2.

In the present embodiment, the arrangement of the lower connecting component 103 is omitted. The piping 1 may further comprise splints 104: the splints 104 are arranged below the lower surface at intervals and matched with the lower surface to form a coextrusion gap 402; and the coextrusion gap 402 is the connecting region 4. The selvage 201 of the zipper 2 is provided with a plurality of through holes 204 for allowing the material of the piping 1 to penetrate through the through holes 204 during coextrusion. In practical production, when the piping 1 is produced, the selvage 201 of the zipper 2 can be arranged in the coextrusion gap 402 at first, and then hot-melted, so that the material of the piping body 101 can be connected with the material of the splints 104 through the through holes 204, thereby enhancing the combination strength. Of course, the connection can also be realized in the coextrusion gap 402 by means of ultrasonic waves or glue, which is not specifically limited here.

In the present embodiment, the zipper 2 may be the one-sided toothed zipper in embodiment 1, and may also be a two-sided toothed zipper, which is not limited here and can be selected according to specific conditions.

### Embodiment 5

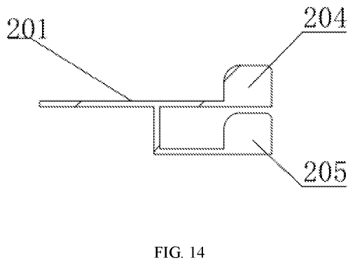

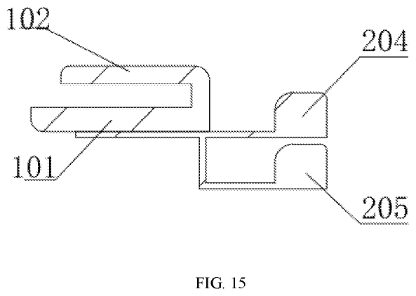

By referring to FIGS. 14-15, the present embodiment is an adjustment based on embodiment 1.

Specifically, in the present embodiment, the zipper 2 comprises the selvage 201, one side of the selvage 201 is provided with two sprockets, i.e., a sprocket 204 and a sprocket 205, and the two sprockets 204 and 205 are arranged up and down in parallel. Of course, in other embodiments, one side of the selvage 201 can also be provided with more than two sprockets arranged up and down in parallel, which is not limited here and can be adjusted according to specific conditions.

In the present embodiment, the zipper is designed as a multilayer zipper structure to realize multilayer connection. When one layer of zipper fails, the connection can be realized through the toothed zipper of other layers.

In the present embodiment, the connection mode between the selvage 201 and the piping body may be: the selvage 201 protrudes into the coextrusion connecting groove 401 formed between the lower connecting component 103 and the piping body 101, and is coextruded therewith: or the selvage 201 is directly coextruded with the lower surface of the piping body 101, or the selvage 201 is placed between the lower surface of the piping body 101 and the splints 104 and coextruded.

### Embodiment 6

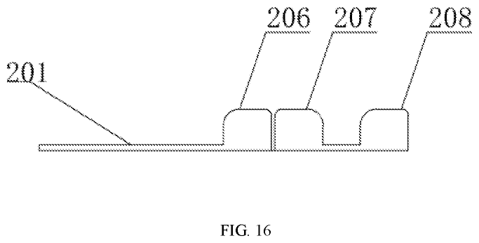

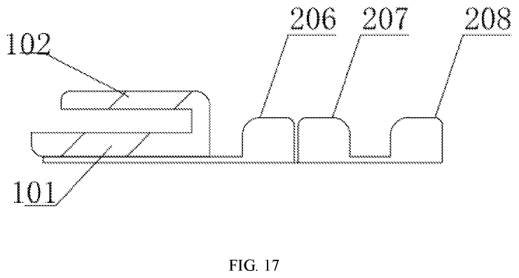

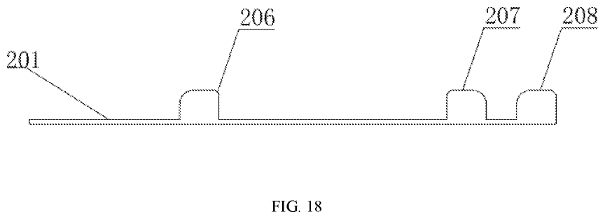

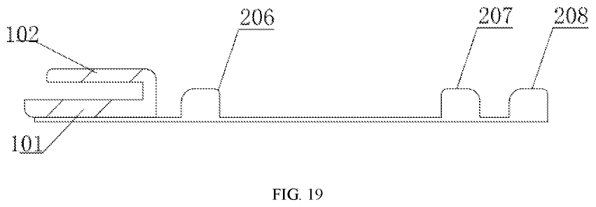

By referring to FIGS. 16-19, the present embodiment is an adjustment based on embodiment 1.

Specifically, in the present embodiment, the zipper 2 comprises the selvage 201; one side of the selvage 201 is provided with three sprockets side by side on the same surface, i.e., a sprocket 206, a sprocket 207 and a sprocket 208; and the sprocket 206, the sprocket 207 and the sprocket 208 are arranged in parallel, wherein the sprocket 206 is connected with the sprocket 207, and the sprocket 208 is connected with the zipper on another box body. When a user needs to place more items in the box body, the sprocket 206 and the sprocket 207 are opened to play a role of increasing the volume of the box body.

Of course, in other embodiments, the number of the sprockets can also be more than two or three, which can be adjusted according to the specific situation and is not limited here.

In the present embodiment, the connection mode between the selvage 201 and the piping body may be: the selvage 201 protrudes into the coextrusion connecting groove 401 formed between the lower connecting component 103 and the piping body 101, and is coextruded therewith: or the selvage 201 is directly coextruded with the lower surface of the piping body 101, or the selvage 201 is placed between the lower surface of the piping body 101 and the splints 104 and coextruded.

### Embodiment 7

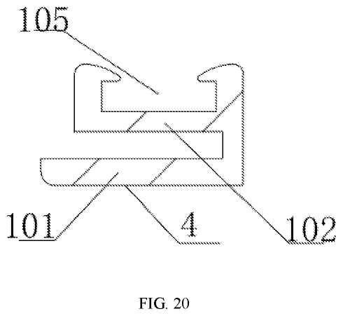

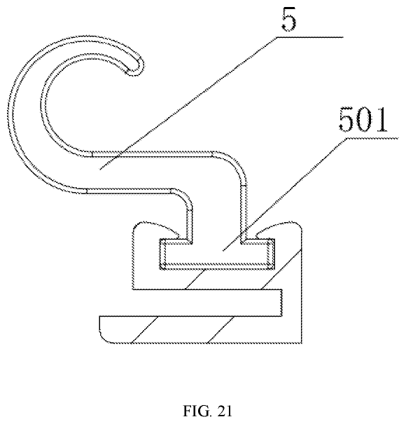

By referring to FIGS. 20-21, the present embodiment is a further adjustment based on embodiments 1-6.

Specifically, in the present embodiment, one surface of the upper connecting component 102 away from the first connecting groove is provided with an accessory connecting structure 105 for connecting an accessory, wherein the accessory is specifically a hook or other structures. When the zipper assembly is used on a bag, the accessory connecting structure 105 is located on the outer side of the bag, and the hook and other accessories are connected through the accessory connecting structure 5, so that things can be hung on the outer side of the bag, thereby increasing the use function.

Further, the accessory connecting structure 105 is a chute structure, one end of the hook 5 has a T-part 501 matched with the chute structure, and the T-part 501 is arranged in the chute structure to realize movable adjustment.

### Embodiment 8

The present embodiment provides a box body, which comprises the piping zipper assembly according to any one of embodiments 1-7. Other structures of the box body can be any box body in the prior art, which is not limited here.

### Embodiment 9

The present embodiment provides a box body production technology applied to the piping zipper assembly in above embodiments 1-8. The purpose of the technology is to solve the above problem of low production efficiency caused by the difficulty in application to automation equipment. The technology of the present embodiment combines the zipper 2 and the piping 1, that is, the coextrusion technology of the zipper 2 and the piping 1. When the piping 1 is produced, the zipper 2 is pre-embedded into the connecting region 4 of the piping 1, and the piping 1 and the selvage 201 of the zipper 2 are fused together through high temperature, so that the piping 1 and the zipper 2 become a whole, thereby achieving the purposes of cladding the edge of the box shell by the piping 1 and facilitating the connection strength by the zipper 2. Then, the whole piping zipper assembly is installed on the box shell by the manipulator, and the piping zipper assembly and the box shell can be connected by ultrasonic waves, glue, sewing and other technologies. The installation time is greatly saved. The production efficiency is increased, and the production cost is reduced. It is also very helpful for purchasing and managing enterprise material.

### Embodiment 10

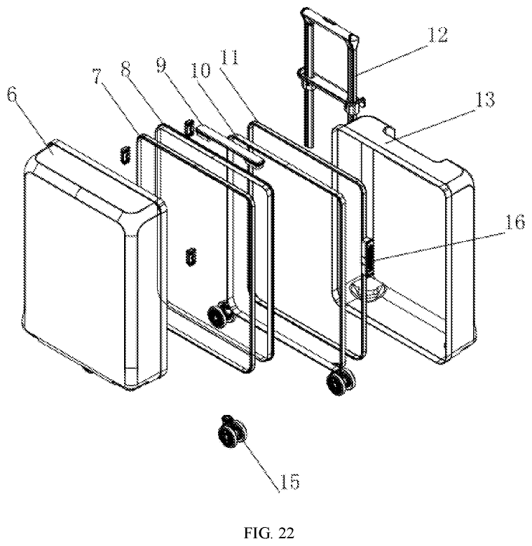

By referring to FIGS. 22-25, the present embodiment provides a box body, which comprises a front box body 6, a rear box body 13 and a zipper assembly. The zipper assembly is connected with the front box body 6 and the rear box body 13. The zipper assembly comprises a left zipper 8, a right zipper 10 and a pull head, and one side of the left zipper 8 and one side of the right zipper 10 are connected through the pull head. The other side of the left zipper 8 is connected with a left piping 7, the other side of the left zipper 8 is coextruded with the left piping 7, and the left piping 7 is connected with the edge of the front box body 6; the other side of the right zipper 10 is connected with a right piping 11, the other side of the right zipper 10 is coextruded with the right piping 11, and the right piping 11 is connected with the rear box body 13, wherein as further described, the left piping 7 is directly connected with the other side of the left zipper 8 in the process of manufacturing and forming, and the right piping 11 is directly connected with the other side of the right zipper 10 in the process of manufacturing and forming.

In the present embodiment, one side of the zipper and the piping are formed by the coextrusion technology into an integral piping zipper assembly. The piping zipper assembly is directly installed on the box shell. Compared with the existing production process in which the piping and the zipper are assembled on the box shell respectively and sewn to the box shell, the present embodiment omits the step that the zipper and the piping are sewn on the piping or sewn on the box shell, greatly saves the installation time and solves the problem of low production efficiency in the existing production process.

Meanwhile, the piping and zipper are produced as an integral piping zipper assembly, which can realize the automation of luggage production. Because two manipulators are needed to move the piping and the zipper to the seam of the box shell respectively in the original solution, the steps are complicated and the production cost is high. The integral piping zipper assembly in the present embodiment can be installed on the box shell by one manipulator only, so that the steps are simple and the production cost is low:

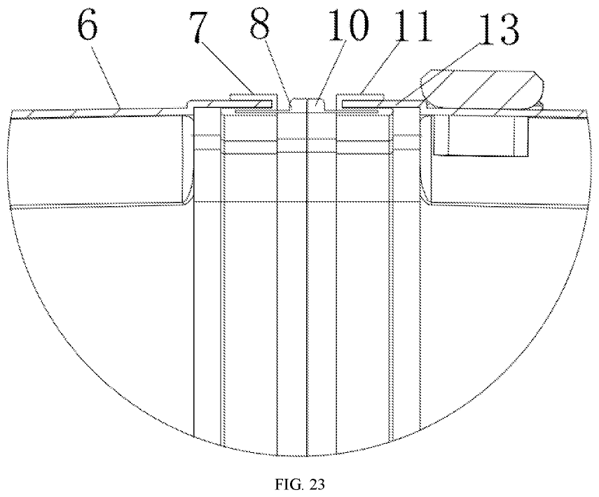

In the present embodiment, as shown in FIG. 23, each of the left piping 7 and the right piping 11 comprises a piping body, and the piping body comprises an upper surface and a lower surface which are opposite: the upper surfaces of the left piping 7 and the right piping 11 are provided with first connecting grooves connected with the front box body and the rear box body; the lower surfaces of the left piping 7 and the right piping 11 are provided with connecting regions; and the selvages of the left zipper 8 and the right zipper 10 are connected to the connecting regions and coextruded with the piping body.

The present embodiment realizes the cladding effect of the left piping 7 and the right piping 11 on the edges of the front box body 6 and the rear box body 13 through the arrangement of the first connecting grooves.

Further, an upper connecting component is connected to the upper surface of the piping body in the present embodiment; and the upper connecting component may be specifically an L-shaped connecting component. One end is arranged on the upper surface and the other end can be matched with the upper surface to form the first connecting groove. In practical installation, the cutting surface of the box shell is directly inserted into the first connecting groove formed between the upper connecting component and the upper surface, and is connected by the technologies of ultrasonic waves or glue or sewing or welding. Of course, in other embodiments, the formation mode of the first connecting groove is not limited to the above, and can also be adjusted according to the specific situation, which is not limited here.

In the present embodiment, the lower surface of the piping body is provided with a lower connecting component, and the lower connecting component may also be an L-shaped connecting component. One end is arranged on the lower surface and the other end can be matched with the lower surface to form a coextrusion connecting groove. An inner cavity of the coextrusion connecting groove is the above connecting region 4. In practical production, the selvages of the left and the right zippers are inserted into the coextrusion connecting grooves of the left and the right pipings respectively, so that the material of the piping body, the material of the lower connecting component and the selvages are coextruded into a whole. Preferably, the coextrusion mode may be hot melting forming. Of course, in other embodiments, the realization mode of coextrusion may also be ultrasonic wave forming or bonding forming, which is not limited here.

In other embodiments, the connection mode between the selvage of the zipper and the piping body is not limited to the above, and can also be as follows:

For example, the arrangement of the lower connecting component is omitted. The selvage of the zipper is directly coextruded with the lower surface of the piping body.

For another example, the arrangement of the lower connecting component is omitted. The piping may further comprise splints: the splints are arranged below the lower surface at intervals and matched with the lower surface to form a coextrusion gap; and the coextrusion gap is the connecting region. The selvage of the zipper is provided with a plurality of through holes for allowing the material of the piping to penetrate through the through holes during coextrusion. In practical production, when the piping is produced, the selvage of the zipper can be arranged in the coextrusion gap at first, and then hot-melted, so that the material of the piping body can be connected with the material of the splints through the through holes, thereby enhancing the combination strength.

In the present embodiment, the left zipper 8 and the right zipper 10 can be both double-sided toothed zippers, or only the left zipper 8 is the double-sided toothed zipper or only the right zipper 10 is the double-sided toothed zipper. The double-sided toothed zipper comprises the selvage, and a first sprocket and a second sprocket which are arranged on both sides of the selvage.

Wherein the first sprocket of the left zipper 8 is connected with the first sprocket of the right zipper 10 through the pull head, and the second sprocket of the left zipper 8 is detachably connected with a lining in the front box body 6. The first sprocket of the right zipper 10 is connected with the first sprocket of the left zipper 8 through the pull head, and the second sprocket of the right zipper 10 is detachably connected with a lining in the rear box body 13. This arrangement makes the lining of the box body detachable, which is convenient for changing and washing the lining. The zipper that makes the lining detachable is integrated with the zipper connected with the front box body and the rear box body, thereby simplifying the structure and simplifying the processing.

Of course, in other embodiments, the concrete structural forms of the left zipper 8 and the right zipper 10 are not limited to the above, and can be adjusted according to the specific situation.

In other embodiments, one side of the selvages of the left zipper 8 and the right zipper 10 is provided with two or more sprockets, and the two or more sprockets are arranged up and down in parallel. Multilayer sprocket design is used for explosion-proof design, that is, when one side fails, connection can be realized through other layers of zippers.

In other embodiments, three or more sprockets are arranged side by side on the same surface at one side of the selvage of the left zipper 8 and/or the right zipper 10. The design of a plurality of sprockets side by side is used to achieve a telescopic effect. Specifically, two sprockets are connected to each other, and the other sprocket is connected with the zipper on the other box body. When a user needs to place more items in the box body, the connected sprockets are opened to play a role of increasing the volume of the box body.

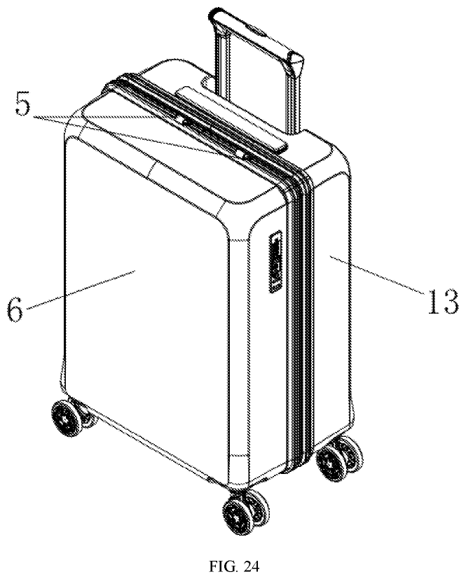

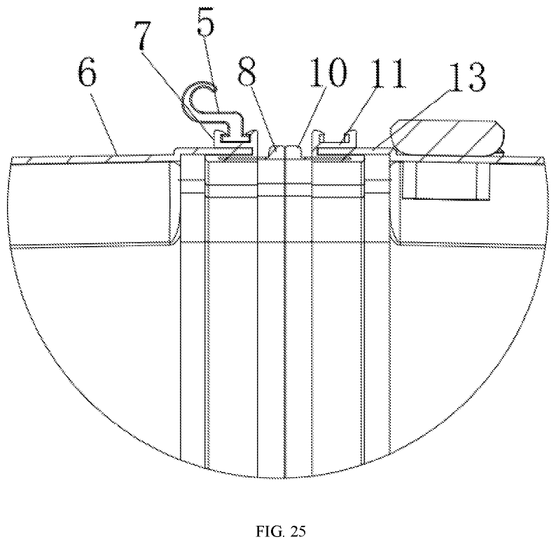

In the present embodiment, as shown in FIGS. 24-25, one side of the left piping 7 and the right piping 11 that faces outside the box body is provided with an accessory connecting structure for connecting an accessory 5, wherein the accessory 5 is specifically a hook or other structures. In the present embodiment, the hook and other accessories are connected through the accessory connecting structure 5, so that things can be hung on the outer side of the box body, thereby increasing the use function.

Further, the accessory connecting structure is a chute structure, one end of the hook 5 has a T-part matched with the chute structure, and the T-part is arranged in the chute structure to realize movable adjustment.

In the present embodiment, as shown in FIG. 22, the box body further comprises a lifting handle 9 and a tension rod 12 which are arranged at the upper end, a lock structure 16 arranged on a side surface, and wheels 15 arranged at the bottom.

The above describes the embodiments of the present invention in detail in conjunction with the drawings, but the present invention is not limited to the described embodiments. Even if various changes are made to the present invention, if these changes belong to the scope of the claims of the present invention and equivalent technologies, the changes still fall within the protection scope of the present invention.

1. A piping zipper assembly, comprising a piping and a zipper;
the piping comprises a piping body, and the piping body comprises an upper surface and a lower surface which are opposite; the upper surface is provided with a first connecting groove connected with a box shell; and the lower surface is provided with a connecting region;
a selvage of the zipper is connected to the connecting region and coextruded with the piping body.

2. The piping zipper assembly according to claim 1, wherein the piping is directly connected with the selvage of the zipper in the process of fabrication and molding.

3. (canceled)

4. The piping zipper assembly according to claim 1, wherein the piping further comprises an upper connecting component; and the upper connecting component is arranged on the upper surface and matched with the upper surface to form the first connecting groove.

5. The piping zipper assembly according to claim 4, wherein one surface of the upper connecting component away from the first connecting groove is provided with an accessory connecting structure for connecting an accessory.

6. The piping zipper assembly according to claim 5, wherein the accessory connecting structure is a chute structure, one end of the accessory has a T-part matched with the chute structure, and the T-part is arranged in the chute structure; and the accessory is a hook.

7. The piping zipper assembly according to claim 1, wherein the piping further comprises a lower connecting component; and the lower connecting component is arranged on the lower surface and matched with the lower surface to form a coextrusion connecting groove, and an inner cavity of the coextrusion connecting groove is the connecting region.

8. The piping zipper assembly according to claim 1, wherein the piping further comprises splints; the splints are arranged below the lower surface at intervals and matched with the lower surface to form a coextrusion gap; and the coextrusion gap is the connecting region.

9. The piping zipper assembly according to claim 1, wherein the selvage of the zipper is provided with a plurality of through holes for allowing the material of the piping to penetrate through the through holes during coextrusion.

10. The piping zipper assembly according to claim 1, wherein the zipper is a double-sided toothed zipper; the double-sided toothed zipper comprises the selvage, and a first sprocket and a second sprocket which are arranged on both sides of the selvage; the first sprocket is combined with another box shell, and the second sprocket is combined with a lining in the box shell.

11. The piping zipper assembly according to claim 1, wherein the zipper comprises the selvage, one side of the selvage is provided with two or more sprockets, and the two or more sprockets are arranged up and down in parallel.

12. (canceled)

13. (canceled)

14. A box body production technology, used for producing a piping zipper assembly and installing the piping zipper assembly to the box body, comprising the following specific steps:
S1: pre-embedding the selvage of the zipper into the connecting region when the piping is produced;
S2: coextruding the piping and the zipper to form the piping zipper assembly;
S3: installing the piping zipper assembly to the box shell by a manipulator to form a box body.

15. The box body production technology according to claim 14, wherein in step S3, the box shell is connected with the first connecting groove of the piping zipper assembly by ultrasonic waves or glue or sewing technology.

16. (canceled)

17. A box body, comprising a front box body, a rear box body and a zipper assembly, wherein the zipper assembly is connected with the front box body and the rear box body; the zipper assembly comprises a left zipper, a right zipper and a pull head, and one side of the left zipper and one side of the right zipper are connected through a pull head;
the other side of the left zipper is connected with a left piping, the other side of the left zipper is coextruded with the left piping, and the left piping is connected with the front box body; the other side of the right zipper is connected with a right piping, the other side of the right zipper is coextruded with the right piping, and the right piping is connected with the rear box body;
wherein the left piping is directly connected with the other side of the left zipper in the process of manufacturing and forming, and the right piping is directly connected with the other side of the right zipper in the process of manufacturing and forming.

18. The box body according to claim 17, wherein each of the left piping and the right piping comprises a piping body, and the piping body comprises an upper surface and a lower surface which are opposite; the upper surface is provided with a first connecting groove connected with the front box body/rear box body; and the lower surface is provided with a connecting region; the selvage of the left zipper/the right zipper is connected to the connecting region and coextruded with the piping body.

19. The box body according to claim 18, wherein the upper surface of the piping body is connected with an upper connecting component, and the upper connecting component is matched with the upper surface to form the first connecting groove.

20. The box body according to claim 18, wherein the lower surface of the piping body is provided with a lower connecting component, the lower connecting component is matched with the lower surface to form a coextrusion connecting groove, and an inner cavity of the coextrusion connecting groove is the connecting region.

21. The box body according to claim 18, wherein splints are arranged below the lower surface of the piping body; the splints are arranged below the lower surface at intervals and matched with the lower surface to form a coextrusion gap; and the coextrusion gap is the connecting region.

22. The box body according to claim 18, wherein the selvages of the left zipper and the right zipper are provided with a plurality of through holes for allowing the material of the left piping and the right piping to penetrate through the through holes during coextrusion.

23. The box body according to claim 18, wherein the left zipper and/or the right zipper is a double-sided toothed zipper; the double-sided toothed zipper comprises the selvage, and a first sprocket and a second sprocket which are arranged on both sides of the selvage;
the first sprocket of the left zipper is connected with the first sprocket of the right zipper through the pull head, and the second sprocket of the left zipper is detachably connected with a lining in the front box body;
the first sprocket of the right zipper is connected with the first sprocket of the left zipper through the pull head, and the second sprocket of the right zipper is detachably connected with a lining in the rear box body.

24. The box body according to claim 18, wherein one side of the selvage of the left zipper and/or the right zipper is provided with two or more sprockets, and the two or more sprockets are arranged up and down in parallel.

25. (canceled)

26. The box body according to claim 18, wherein the left zipper and the left piping, and the right zipper and the right piping are formed by hot melting or ultrasonic waves or bonding.

27. The box body according to claim 18, wherein one side of the left piping and/or the right piping that faces outside the box body is provided with an accessory connecting structure for connecting an accessory, wherein the accessory connecting structure is a chute structure, one end of the accessory has a T-part matched with the chute structure, and the T-part is arranged in the chute structure; and the accessory is a hook.

28. (canceled)
